(19) United States
(12) Patent Application Publication
(10) Pub. No.: US 2005/0071378 A1
(43) Pub. Date: Mar. 31, 2005

(54) Method of storing applications on removable storage

(76) Inventor: Alan G. Smith, Allen, TX (US)

Correspondence Address: TEXAS INSTRUMENTS INCORPORATED, P O BOX 655474, M/S 3999, DALLAS, TX, 75265, US

(21) Appl. No.: 10/674,734

(22) Filed: Sep. 30, 2003

(51) Int. Cl. G06F 17/30

(52) U.S. Cl. 707/200

(57) ABSTRACT

A system and method of storing applications on removable memory or storage with a separate applications registry maintained on the removable memory. Upon insertion the data base on the removable memory or storage can be merged with the applications database on the computer system to form a virtual registry. Preferred embodiments of the present are directed to handheld computer devices such as calculators and personal digital assistants. Applications can be easily integrated with the computers system applications upon insertion of the memory containing the application preferably such that nothing need be stored on the computer to support those applications on the removable memory. Where there are multiple applications for a single data type, the system first associates the application most likely desired by the user to run the desired data type.

### TECHNICAL FIELD OF THE INVENTION

This invention relates to storage management on a computer, and more particularly to storing a computer application program on removable memory or other removable storage.

### BACKGROUND OF THE INVENTION

Removable storage is becoming widespread and increasingly useful in a variety of computer systems. In most of the new applications, removable memory is used to store data files. It is also advantageous to store applications on removable memory or other removable storage. In typical computer systems, storing applications on the removable memory is cumbersome to install and un-install the programs so that the system maintains a current file extension table without broken links to removed applications on the removable memory.

The computer system software needs to be able to recognize a new application on the removable memory and have all data types associated with that application to be correctly updated when the memory is attached. The system must also be able to determine when the application is no longer present when the removable memory is removed from the system. This is necessary to prevent the system from having invalid links to software that has been removed.

In a classroom environment, the teacher could hand out a removable memory or storage with an application as well as data files for a test or other activity. It is desirable for a computer such as a handheld computer device to be able to efficiently and easily handle the new application and data files into the file system on the device.

### SUMMARY OF THE INVENTION

The present invention overcomes problems associated with the described prior art. In a preferred embodiment, a separate applications database is maintained on the removable storage that keeps track of data types for the application on the removable storage. Upon insertion the data base on the removable storage can be merged with the applications database on the computer system.

Preferred embodiments of the present are directed to handheld computer devices such as calculators and personal digital assistants.

An advantage of an embodiment of the present invention is that applications can be easily integrated with the computers system applications upon insertion of the memory containing the application. In a preferred embodiment the application table is dynamically updated to reflect the applications on any removable memory in such a way that nothing need be stored on the computer to support those applications on the removable memory. Embodiments of the present invention also allow the computer system to keep track of the most up to date copy of the application, whether on the removable memory on the computers main memory.

Another advantage of the present invention is that the application most likely desired by the user is used to run the desired data type.

### BRIEF DESCRIPTION OF THE DRAWINGS

FIG. 1 illustrates a physical table containing an application data base according to the prior art.

FIG. 2 illustrates a computer with a removable memory containing an application program according to an embodiment of the prior art.

FIG. 3 illustrates a physical table and a corresponding virtual table containing an application data base according to an embodiment of the present invention.

FIGS. 4a, b illustrate flow diagrams according to an embodiment of the present invention.

### DETAILED DESCRIPTION OF THE INVENTION

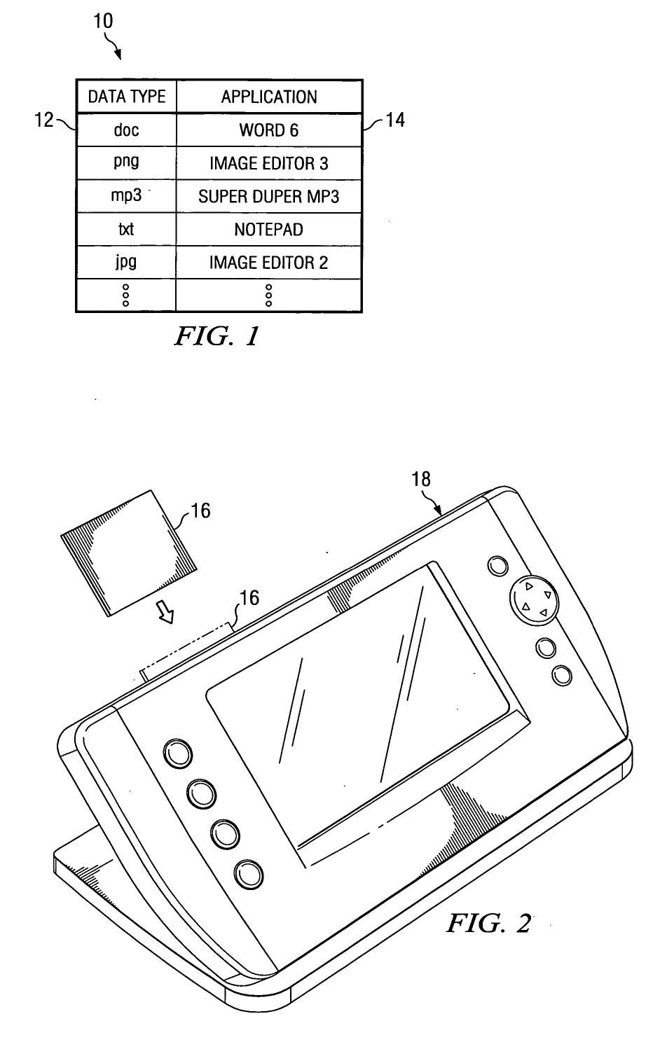

FIG. 1 represents a data extension table 10 for an operating system according to the prior art. The table lists a number of data file types that are represented by a file extension 12. The file extension may be one or more characters and is typically a three letter extension in common computer systems. Each data file type is associated with one or more applications 14 that use that file type. This data table exists as a physical table somewhere in system memory or stored on a system disk file.

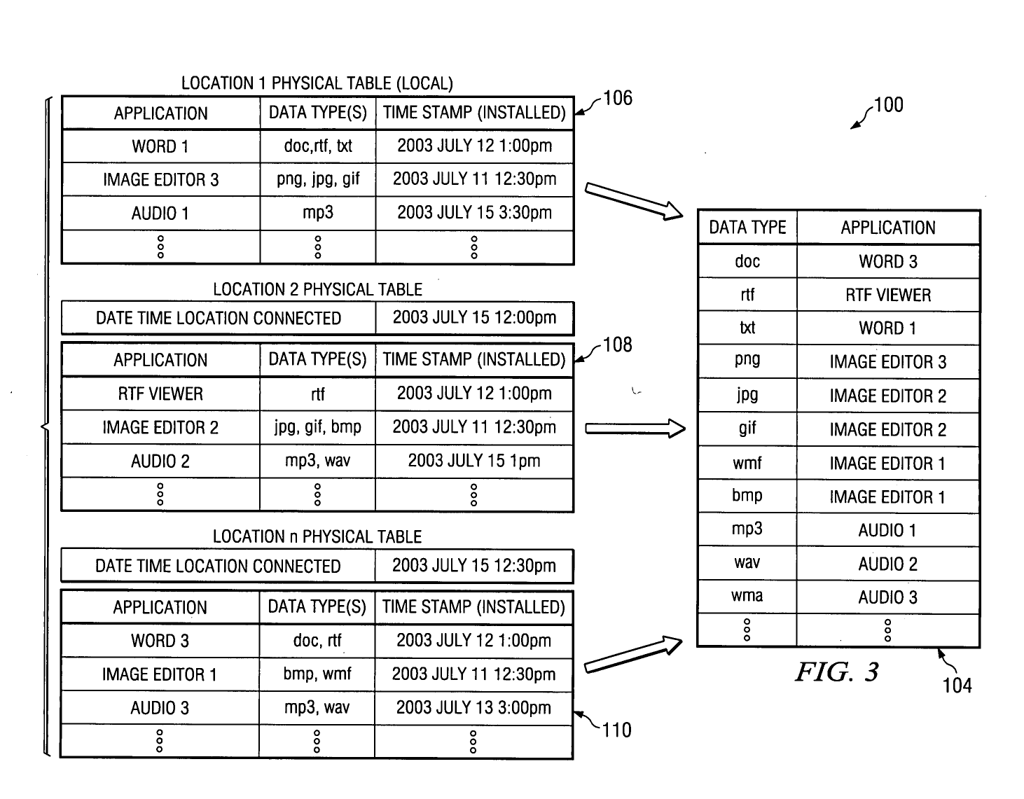

FIG. 2 illustrates a computer with a removable storage or memory 16 having a data extension table and an application program according to an embodiment of the present invention. The physical data extension tables on the computer and on the removable memory are merged into a virtual table data extension table (not shown). The removable storage 16 is shown inserted into the portable computer 18.

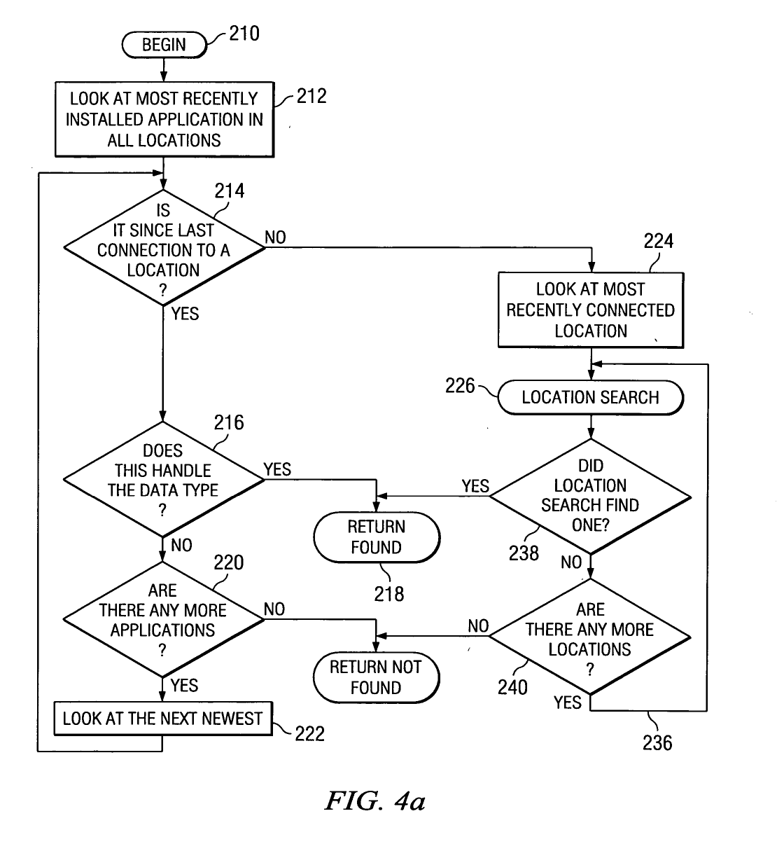

FIG. 3 illustrates a data extension table 100 constructed according to an embodiment of the present invention. This embodiment shows a number of physical tables 102 that are merged into a virtual table 104. The first physical table is the local table 106. The local table 106 resides in local memory to the system like in the prior art. There can be one or more additional physical tables 108, 110 that reside on removable memory. In FIG. 2 a second table 108 is shown along with a final table designated as Table n 110.

The local physical table 102 includes a data file type 112 represented by a file extension, that is associated with one or more applications 114 that use that file type. Preferably, this table also includes a time stamp 116 for each file extension entry. Similarly the other physical tables 108, 110 include the same entries. The physical tables 102 are merged into a virtual table 104 by the operating system or by a system computer program or routine after detecting the insertion of the removable memory module.

In a preferred embodiment, the virtual table 104 is constructed to resemble the prior art physical table. The virtual table 104 lists the file types with their associated applications. For data type entries in the virtual table that had more than one application program, the most recent application is listed in the table.

FIG. 3 shows a flow diagram according to an embodiment of the present invention. The flow diagram could be use by the host system to process the physical tables 106 to form the virtual table 104, or the flow diagram could be used to determine the application to be used without forming the virtual table.

The flow diagram describes the process of determining which application software to use for a given file type according to the present invention. The invention first gives priority to an application installed after the insertion of removable memory containing the data file, and second to an application on the most recently installed removable memory and last to an application in physical local memory. Advantageously the present invention associates the application most likely desired by the user to run the desired data type. For example, if a user adds a removable memory which contains both an application and a data type associated with that data type, the user likely wants to use that application. If the user after installing a removable memory installs an application for the data type, the decision process will choose the later installed application since that is likely what the user wants. The system may also allow the user to choose another application for a data file to override this process.

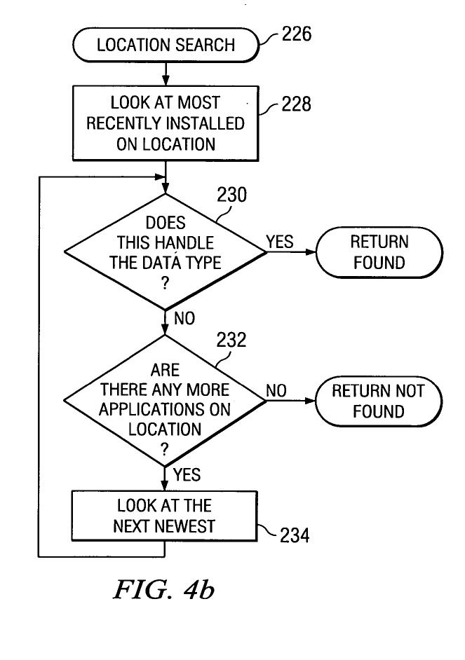

FIGS. 4a and 4b show a flow diagram to implement the process described above according to an embodiment of the present invention. The process determines an application to be associated with a file type, usually indicated by the data file extension. The process is shown as a single scan for a given file type, but can be reiterated for each file type to build a virtual data type extension table 104. The process begins 210 in FIG. 4a by looking at the most recently installed application 212 and examining the time stamp in the physical tables 106 in FIG. 3. If the application was installed since the last connection of the module 214, and the application handles the data type being determined 216 then the routine returns a found application 218 for the current data type. If the application does not handle the data type and there are more applications to check 220, then the next newest application 222 is checked. If there are no other applications to check, then not found is returned. This sequence will check for an application installed after the connection to the removable memory containing the data file currently of interest.

If no applications are found since the last insertion of the module containing the data file, then applications installed before are examined. The applications installed before are examined in order of the most recently connected location 224. The first most recently connected location is determined from the time stamp associated with the inserted module. The process then proceeds to the Location Search loop 226 shown in FIG. 4b. The location search loop looks at the most recently installed application 228 on the currently being searched location. If the first application handles the needed data type 230, then it returns a found application to the system. If not, then a check is made for more applications 232. The next newest application is checked 234 as long as there are more application on the presently being searched location.

After all applications on the presently being search location are searched, the Location search loop returns a found or not found to the Location search call 226 in the previous loop. The process loop 236 after this call then checks if the location search returned a found application 238. If the location search returned not found, then the process checks for additional locations 240 and continues the loop for any additional locations, or returns not found if there are no more locations to search.

### Other Embodiments

Although the present invention has been described in detail, it should be understood that various changes, substitutions, and alterations could be made hereto without departing from the spirit and scope of the invention as defined by the appended claims.

1. A computer system having application programs stored on removeable storage comprising:
a. a computer system having a first data type table that stores application and file type associations;
b. at least one removable memory module that can be inserted into the computer system such that the storage locations on the module become assessable to the computer system,
c. an application program stored on the removable memory module;
d. a second data type table stored on the removable memory module;
e. a system computer software routine to combine the first and second data type table to form a virtual extension table that is used to determine which application is to be used for a given file type.

2. The computer system of claim 1 wherein the application and file type associations are determined by a file name extension associated with a specific file type.

3. The computer system of claim 1 wherein the computer software routine determines the priority of associating an application and file type in the virtual table by giving first priority to any application installed after insertion of the removable memory module.

4. The computer system of claim 3 wherein the computer software routine determines the priority of associating an application and file type in the virtual table by giving second priority to any application installed on recently connected removable memory modules with the more recently installed module given higher priority over subsequently installed memory modules.

5. A portable handheld computer having application programs stored on removeable memory comprising:
a. a computer system having a first data extension table that stores application and file extension associations;
b. at least one removable memory module that can be inserted into the computer system such that the storage locations on the module become assessable to the computer system,
c. an application program stored on the removable memory module;
d. a second data extension table stored on the removable memory module;
e. a system computer software routine to combine the first and second data extension table to form a virtual extension table that is used to determine which application is to be used for a given file type.

6. The computer system of claim 1 wherein the application and file type associations are determined by a file name extension associated with a specific file type.

7. The computer system of claim 1 wherein the computer software routine determines the priority of associating an application and file type in the virtual table by giving first priority to any application installed after insertion of the removable memory module.

8. The computer system of claim 3 wherein the computer software routine determines the priority of associating an application and file type in the virtual table by giving second priority to any application installed on recently connected removable memory modules with the more recently installed module given higher priority over subsequently installed memory modules.

9. A method of storing applications on removeable storage in a computer system comprising the following steps:
a. storing on the computer system a first data extension table that stores application and data file extension associations;
b. inserting at least one removable storage module into the computer system such that the storage locations become assessable by the computer system, with an application program stored on the removable storage module;
c. storing a second data type table on the removable storage module; d. determining which application program to execute with a data file according to a virtual extension table made from the combination of the first and second data extension tables.

10. The method of claim 9 wherein the computer software routine determines the priority of associating an application and file type in the virtual table by giving first priority to any application installed after insertion of the removable storage module.

11. The method of claim 10 wherein computer software routine determines the priority of associating an application and file type in the virtual table by giving second priority to any application installed on recently connected removable storage modules with the more recently installed module given higher priority over subsequently installed storage modules.
